(19) United States
(12) Patent Application Publication
(10) Pub. No.: US 2008/0077541 A1
(43) Pub. Date: Mar. 27, 2008

(54) Systems and methods for using billing information to dynamically route vehicles

(75) Inventors: Christopher M. Scherer, Rutland, VT (US); S. Graham Stevens, Charlotte, NC (US); John Cronin, Jericho, VT (US); Michael Bielski, Colchester, VT (US); Brian Van Dam, Scarborough, ME (US)

Correspondence Address: WILMERHALE/DC, 1875 PENNSYLVANIA AVE., NW, WASHINGTON, DC, 20004, US

(73) Assignee: Casella Waste Systems, Inc., Rutland, VT (US)

(21) Appl. No.: 11/515,788

(22) Filed: Sep. 6, 2006

(51) Int. Cl. G06F 17/00

(52) U.S. Cl. 705/400

(57) ABSTRACT

Systems and methods for routing waste collection vehicles. In one embodiment, a method includes determining a location of a waste collection vehicle on a route. A data repository includes a plurality of customer accounts. Each customer account includes a billing status and a customer location. The data repository is monitored to detect changes to the billing status of at least one customer account. A waste collection vehicle route is generated based on detecting a change to the billing status of at least one customer account associated with the route and a location of the waste collection vehicle at the time of the detected change. The route update is transmitted to the waste collection vehicle, thereby enabling the waste collection vehicle to provide service or not provide service at the customer location associated with the change to the billing status.

### RELATED APPLICATIONS

This application is related to the following copending and commonly assigned patent applications, which are incorporated herein by reference in their entirety: “Systems and Methods for Identifying Banned Waste in a Municipal Solid Waste Environment,” having application Ser. No. 11/433,505, filed on May 15, 2006; “Systems for and Methods of Asset Management In a Waste Management Service Environment,” having application Ser. No. 11/435,688, filed on May 18, 2006; and “Systems and Methods for Identifying and Collecting Banned Waste,” having application Ser. No. and attorney docket 105452-308, filed on Sep. 6, 2006.

### BACKGROUND OF THE INVENTION

1. Field of the Invention

Embodiments of the present invention relate to vehicle routing and, more particularly, to systems and methods that utilize customer billing and/or account status information to dynamically route vehicles.

2. Background of the Invention

Waste management companies provide residential, commercial, and municipal waste management and recycling services for communities and organizations. Customers can range, for example, from single residences to entire towns or companies. Municipalities may contract with a waste management service provider to handle their municipal solid waste (MSW). MSW is garbage, refuse, and other discarded materials that result from residential, commercial, industrial, and community activities.

Residential and commercial customers that waste management companies service generally pay their bills in a predetermined fashion, based upon the terms of their service contract. For example, a residential customer who has his trash picked up once a week may pay a bill at the end of every month for the services performed, whereas a commercial client who has a roll-off container emptied only once or twice a month may pay a bill at the end of every quarter.

One situation that waste management companies face is the inability to evaluate a customer's account status in a timely manner. For example, there may be a lag time of days or weeks between initial suspension of a customer's account and when a driver of a collection vehicle providing service to the (suspended) customer becomes aware of the suspension.

The status of a customer account, such as “active” or “suspended,” determines whether a vehicle will be routed to provide service to a customer. A waste management company, for example, may suspend one or more services of a customer whose account is delinquent. By updating customer account information with current billing data and transmitting the updated account information to pertinent in-transit or on-route vehicles, waste management companies could reinstate or suspend services during the course of a collection vehicle servicing a route.

We have determined that there exists a need to assess the status of customer accounts payable information in, for example, a waste collection environment, and utilize such information to dynamically modify collection vehicle routes to provide or eliminate customer service.

### BRIEF DESCRIPTION OF THE DRAWINGS

FIG. 1 is an exemplary block diagram of a waste collection invoicing and account status system in accordance with an embodiment of the present invention.

FIG. 2 is an exemplary block diagram in accordance with an embodiment of the present invention.

FIGS. 3A and 3B, taken together, is an exemplary method of transmitting route updates to collection vehicle personnel.

FIG. 4 is an exemplary data repository in accordance with an embodiment of the present invention.

### DETAILED DESCRIPTION OF EMBODIMENTS OF THE INVENTION

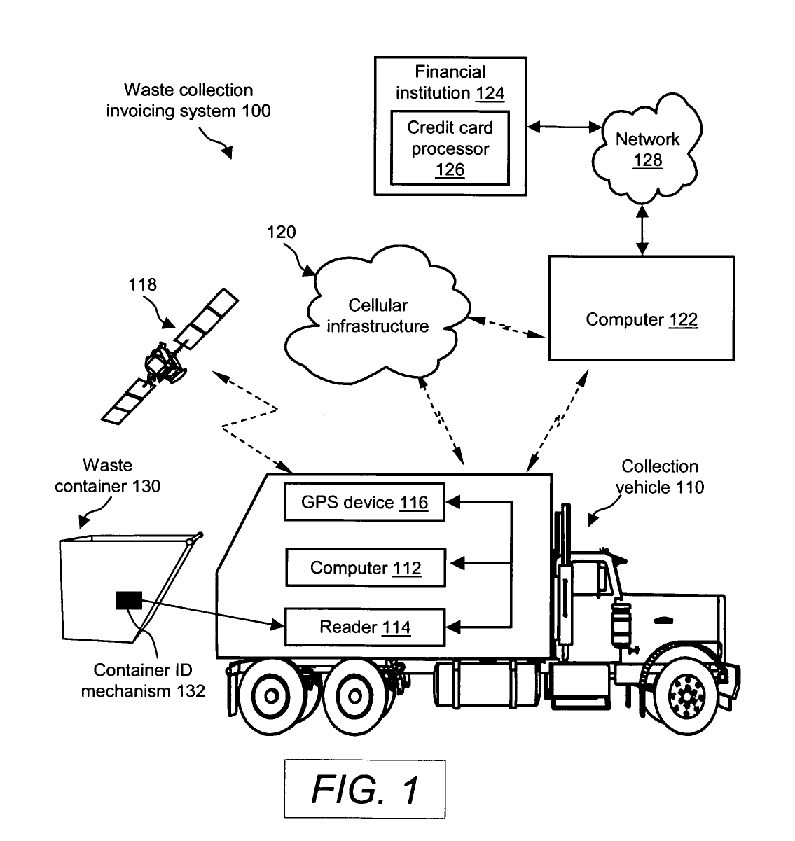

FIG. 1 is an exemplary block diagram of a waste collection invoicing and account status system 100 in accordance with an embodiment of the present invention. System 100 includes a collection vehicle 110 that includes computer 112, reader 114, and global positioning system (GPS) device 116.

System 100 further includes GPS satellites 118, cellular infrastructure 120, computer 122, financial institution 124, credit card processor 126, and network 128. System 100 also includes a waste container 130 with an attached container identification (ID) mechanism 132.

Collection vehicle 110 can be, for example, a conventional waste hauling truck that is used to collect refuse from a plurality of originator points. Originator points are, for example, commercial and industrial sites, residential curbsides, and/or community drop-off points.

Computer 112 can be a standard laptop or desktop computer. Alternatively, computer 112 can be a mobile computing device that is physically integral to vehicle 110, such as supplied by Glacier Computer (New Milford, Conn.) or by Mobile Computing Corporation (Charlottesville, Va.). Computer 112 includes industry standard components (not shown) such as a standard user interface and display, a processor, and a storage device. Storage device can be a hard disk drive or other suitable non-volatile storage. Computer 112 also includes a clock device that can be used to provide timestamp data, and various standard interfaces such as a universal serial bus (USB) that can be used to connect to external devices such as reader 114 and GPS device 116. A wireless communication link enables computer 112 to communicate with computer 122.

Reader 114 is a commercially available RFID tag reader system, such as the TI RFID system, manufactured by Texas Instruments Incorporated (Dallas, Tex.). GPS device 116 is a standard global positioning system that supplies position data such as digital latitude and longitude. GPS device can be the GEOTAB GPS system, which is a commercially available vehicle fleet and productivity management system, manufactured by GEOTAB (Burlington, Ontario, Canada). Computer 122 can be a standard laptop or desktop computer.

Financial institution 124 can utilize credit card processor 126, which can be any standard credit card processor able to process credit transactions, to electronically transfer and/or receive funds. Credit transactions can be done over the telephone, online via the internet, or through the mail. Alternatively, credit card processor 126 can be a third party credit card payment processor, such as provided by First Data Corporation (Greenwood Village, Colo.). Computer 122, financial institution 124, and credit card processor 126 can communicate with each other via network 128.

Waste container 130 can be standard, large-volume receptacles, such as a dumpster, a roll-off container, or a 90-gallon toter that is used for residential curbside collection. Container ID mechanism 132 can be, for example, a radio frequency identification (RFID) tag device that can be used to identify waste container 130. Alternatively, container ID mechanism 132 can be a bar code or other identifier that uniquely identifies waste container 130. Container ID mechanism 132 is scanned by reader 114, in order to extract the identification data thereon. When container ID mechanism 132 is read, the RFID data is transmitted to computer 112, and subsequently transmitted to computer 124.

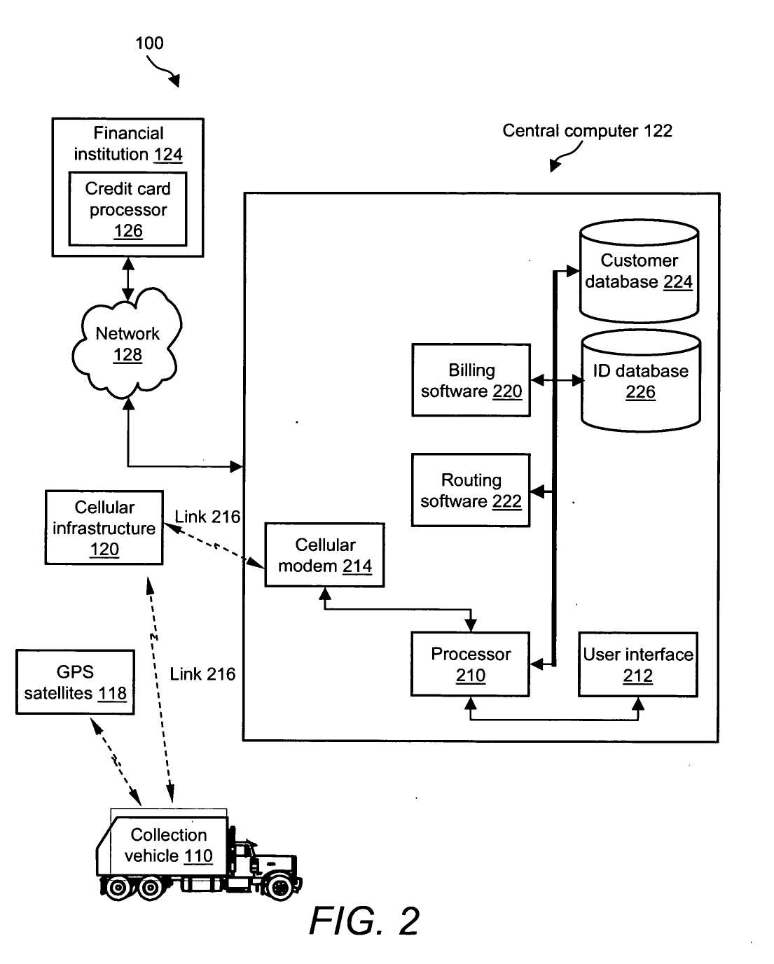

FIG. 2 is an exemplary block diagram in accordance with an embodiment of the present invention. Computer 122 includes standard components, such as a processor 210, user interface 212, modem 214, and wireless link 216. Billing software 220, and routing software 222 is provided, the functionality of which can be combined as desired for implementation and/or efficiency purposes. Computer 122 also contains (or utilizes) one or more databases, such as customer database 224 and ID database 226.

Processor 210 can be a standard general purpose microprocessor, such as a Pentium or a PowerPC microprocessor. User interface 212 can be a standard user interface for inputting and displaying data, such as a keyboard, mouse, or touch screen with accompanying menus and prompts. Modem 214 can be a standard wireless modem manufactured, for example, by CYNET, Incorporated (Houston, Tex.). Wireless link 216 can be one or more wireless data communications links. Long range data links such as a Code Division Multiple Access (CDMA) 1×EV-DO or General Packet Radio Service (GPRS) link may be used. Short range wireless links such as Wi-Fi may also be used.

Billing software 220 may be standard commercially available software that evaluates the current financial standing of customer accounts, such as balances due and the payments received from customers. Billing software such as Soft-Pak, from Soft-Pak, Inc. (San Diego, Calif.), may be used. Billing software 220 can operate in conjunction with routing software 222, and/or financial institution 124 through standard network and communication protocols. Billing software 220 updates customer database 224 with any payment received from financial institution 124 or other payment source. Billing software 220 also updates the customer database 224 when payment has not been received for a customer account for a specific period of time.

Routing software 222, such as eZroute provided by Wastenet, LLC (Houston, Tex.), utilizes customer database 224 and billing data to generate routes for collection vehicles 110. Routing software 222 is used in conjunction with data generated by billing software 220 to schedule customer pick-ups.

Customer database 224 and ID database 226 are standard repositories, such as databases, that contain data. The data stored in these repositories can be stored on a single or multiple storage mediums. More particularly, customer database 224 contains data pertaining to customer accounts such as account payment status, amount due, and address, as shown below in Table 1.

TABLE 1

| Customer | | | | | | Collection | |
|---|---|---|---|---|---|---|---|
| and | Last | Last | Last | Months | Balance | Service | Date |
| Address | Service | Invoice | Payment | Delinquent | Due | Status | Updated |
| J. Smith | Oct. 01, 2005 | Oct. 01, 2005 | Oct. 15, 2005 | 0 months | $0.00 | Normal | Nov. 01, 2005 |
| 10 Pine | | | | | | Service | |
| St. | | | | | | | |
| T. Jones | Oct. 01, 2005 | Oct. 01, 2005 | Sep. 15, 2005 | 1 month | $100.00 | 1^{st} Alert | Nov. 01, 2005 |
| 15 Elm | | | | | | Sent | |
| St. | | | | | | | |
| J. Doe | Oct. 01, 2005 | Oct. 01, 2005 | Jul. 15, 2005 | 3 months | $300.00 | Service | Nov. 01, 2005 |
| 23 Oak | | | | | | Suspended | |
| St. | | | | | | | |
| S. Knight | Oct. 01, 2005 | Oct. 01, 2005 | Aug. 15, 2005 | 2 months | $200.00 | 2^{nd} Alert | Nov. 01, 2005 |
| 3 Apple | | | | | | Sent | |
| St. | | | | | | | |
| R. Brown | Jul. 01, 2005 | Oct. 01, 2005 | Nov. 01, 2005 | 0 months | $0.00 | Service | Nov. 01, 2005 |
| 16 State | | | | | | Reinstated | |
| St. | | | | | | | |

Table 1 above shows exemplary data stored in customer database 224. Billing software 220 may use the data stored in customer database 224 to identify delinquent accounts. Table 1 identifies three delinquent customer accounts, T. Jones, S. Knight, and J. Doe, as shown by their collection service status. In this example, billing software 220 transmits an alert to the customer and/or collection vehicle 110 after an account is one month past due, transmits a second alert to the customer and/or collection vehicle 110 after an account is two months past due, and suspends collection service for an account that is three months past due. A different timing and number of alerts may, of course, be implemented as desired. ID database 226 contains data that is associated with assets of the waste collection service provider, such as data stored on container ID mechanisms 132.

When system 100 is in operation, one or more collection vehicles 110 are deployed on routes that are generated using, for example, routing software 222. Each collection vehicle 110 travels along the generated route of collection locations and, at each collection location, reader 114 scans the one or more container ID mechanisms 132, in order to extract the identification number thereon. Reader 114 transmits the ID data extracted from container ID mechanisms 132 to computer 112. Computer 112 transmits the ID data received from reader 114 to computer 122 via cellular infrastructure 120, wireless link 216, and modem 214. The ID data of each waste container 130 is associated with a particular customer. Therefore, by reading the data on container mechanism 132, routing software 222 can associate the data with a customer address to determine the present location of collection vehicle 110. Alternatively, GPS satellites 118 can be used to determine the present location of collection vehicle 110.

Billing software 220 processes the data stored in customer database 224 in order to determine the status of customer accounts. Customer accounts can have a status, for example, of delinquent or in good standing. Delinquent accounts can be determined, for example, by comparing the current date with the payment due date. Accounts are determined to be delinquent if the amount of time between the current date and the payment due date is greater than a predetermined threshold. Accounts in good standing are those where the amount of time between the current date and the payment due date is less than a predetermined threshold. Further an account changes from delinquent to good standing when sufficient payment is received.

As billing software 220 monitors the status of customer database 220, it communicates changes to routing software 222, so that route modifications can be generated based on accounts that are suspended or restored to good standing while collection vehicle 110 is en route. Those accounts that are suspended because of failure to pay are removed from the collection vehicle 110 route (that is they will not be posted as the next stop to the drivers log either in advance or on real time), and those that are reinstated because of a received payment are added to the collection vehicle 110 route. The collection vehicle 110 route generated by routing software 222 is then transmitted to the collection vehicle 110 while it is en route.

Alternatively, the process described above can be carried out on computer 112. Updates to customer database 224 and ID database 226 can be made while the collection vehicle 110 is en route.

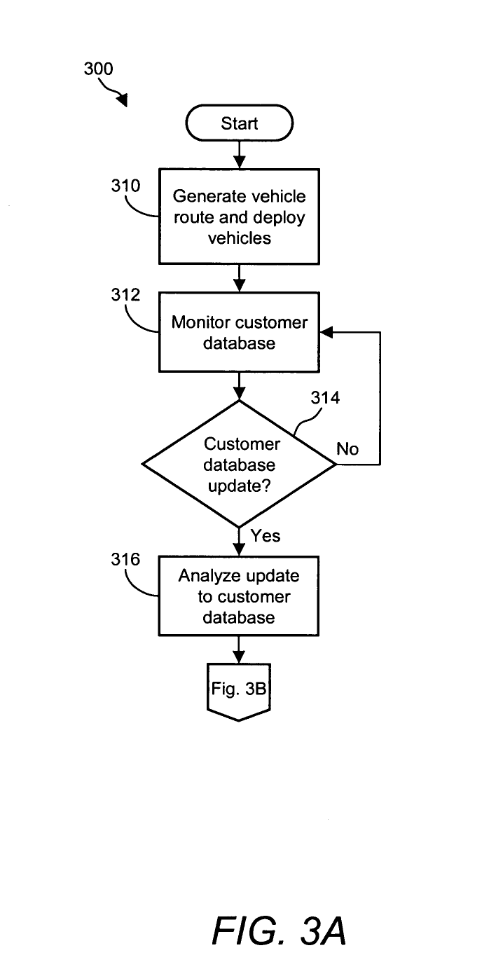

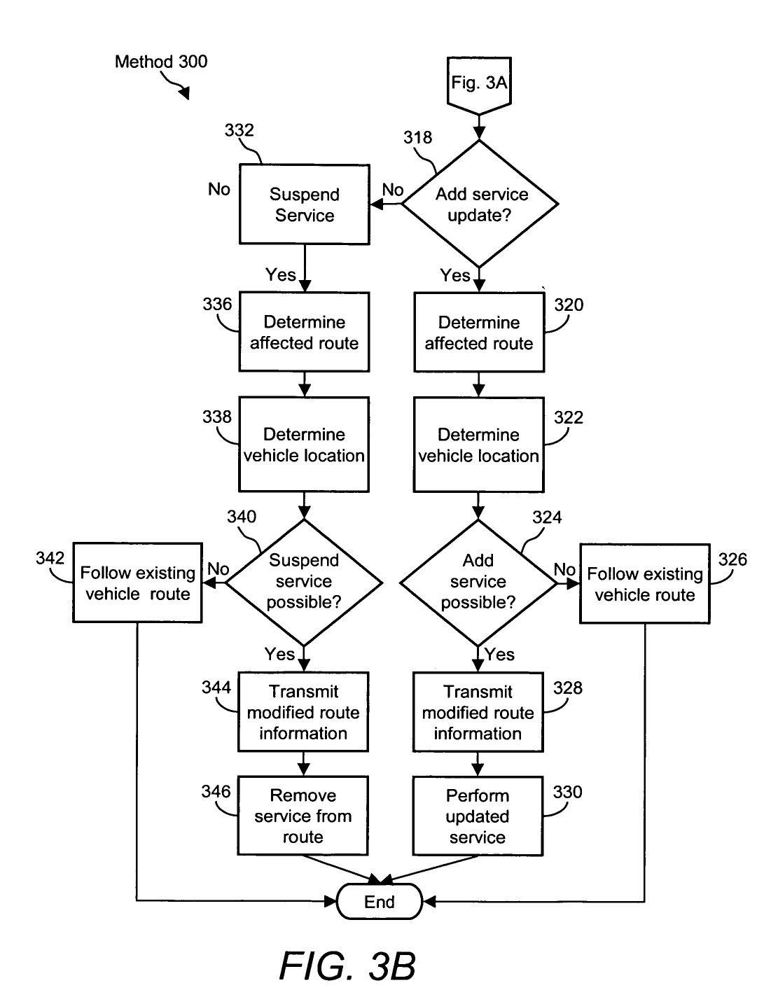

FIGS. 3A and 3B, taken together, illustrate an exemplary method 300 for informing collection vehicle 110 personnel of updates to vehicle routes. At step 310, routing software 222 generates collection vehicle 110 routes, and one or more collection vehicles 110 are deployed accordingly. Additionally, in generating the vehicle routes, routing software 222 considers whether a customer's collection service has been suspended because of delinquency, or reinstated due to recent payment, as provided by billing software 220. Collection vehicle 110 routes generated by routing software 222 exclude the pickup locations of any customers whose collection service has been suspended. Similarly, if during the time a collection vehicle 110 is servicing a vehicle route, an account has been reinstated due to payment, that customer's collection location can be added to the collection vehicle 110 route.

For example, in Table 1, if customer database 224 indicates that a payment has not been received for three months or more, billing software 220 changes the collection service status, or billing status, to “Service Suspended.” The change is communicated or detected by routing software 222, which removes this customer's service from the appropriate collection vehicle 110 route. In contrast, if customer database 224 indicates that payment has been received, collection service is changed back to normal, which is shown as “Service Reinstated”, and routing software 222 reinstates this customer's service to the appropriate collection vehicle 110 route.

At step 312, billing data within customer database 224 is monitored by billing software 220, in order to detect customer account status changes. Monitoring of billing data may be continuous, periodic, or on any other schedule and/or time as necessary to provide updates to collection vehicle 110 in time for one or more route changes to be made during a scheduled route.

For example, referring to Table 1, customer R. Brown had collection service reinstated on Nov. 01, 2005, because full payment was credited to his delinquent account on Nov. 01, 2005. This full payment is indicated in Table 1 by recording the “Balance Due” to $0.00 and the “Months Delinquent” to zero (0). Furthermore, the “Collection Service Status” is reinstated to “Service Reinstated”. This reinstatement of R. Brown's collection service is communicated to or detected by billing software 220.

As is also shown in Table 1, J. Doe's account was suspended on Nov. 01, 2005 because payment on her delinquent account has not been received since Jul. 15, 2005, which is a three-month delinquency and cause for a suspension in collection services. Other timer periods for suspension may also be used. In this example, if a required payment for a customer account is not received for three months, this is recorded as “3 Months” delinquent, and “Collection Service Status” is recorded as “Service Suspended.”

At decision step 314, billing software 220 monitors and updates the billing data within customer database 224. At step 316, routing software 222 analyzes the updated billing data to determine whether a change to a collection route already in progress is necessary, based on the data in customer database 224. If, at decision step 314, billing software 222 does not detect a suspension or reinstatement to the billing date within customer database 224, then monitoring continues at step 312.

At decision step 318, billing software 220 determines whether the update to the vehicle route is a reinstatement-service update, in which case the route that is affected by the reinstated service is determined, at step 320 by routing software 222. At step 322, the current location of collection vehicle 110 along the update-affected route, is determined, by using data scanned by reader 114 or GPS device 116. For example, at each collection site along the update-affected route, collection data, which includes the RFID data of each respective container ID mechanism 132, is scanned by identification read 114 and transferred to computer 122. This RFID data is compared against RFID data stored within ID database 226 to determine the address at which collection vehicle 110 is presently located. This is possible, because each container ID mechanism 132 is associated with only one customer address. Alternatively, or as a backup to using identification reader 114, the current location of collection vehicle 110 can be obtained directly by using GPS device 116. Location information obtained from GPS device is also transmitted to computer 122 for use by routing software.

At decision step 324, routing software 222 compares the received location of collection vehicle 110 along the affected customer route, as determined in step 322, with the location of the newly reinstated customer, obtained from customer data repository 224, in order to determine whether the reinstate-service update is logistically feasible. If the location of collection vehicle 110 with respect to the pickup location of the newly reinstated customer does require collection vehicle 110 to substantially deviate from its predetermined route as determined by routing software 222, then, the existing vehicle 110 route is substantially followed at step 326.

If, at decision step 324 it is determined that reinstated service is feasible, then, at step 328, modified route information, including one or more added pickup locations, resulting from a reinstate-service update, is transmitted at step 328 from computer 122 to computer 112 via, for example, cellular infrastructure 120. At step 330, the updated, reinstated service is performed.

Step 332 is a suspend service 332 scenario. Steps 336 and 338 are performed in the same or a similar manner as steps 320 and 322. At decision step 340, routing software 222 compares the current location of collection vehicle 110 along the affected customer route, as determined in step 338, with the location of the newly suspended customer, to determine whether the suspend service update is logistically feasible. If the location of collection vehicle 110 with respect to the pickup location of the newly suspended customer indicates that collection vehicle 110 has already performed service for the newly suspended customer, then the existing vehicle 110 route is followed at step 342.

If it is determined at decision step 340 that customer service can be suspended en route, then, at step 344, computer 122 transmits modified route information to vehicle 110. At step 346,the driver of vehicle 110 is notified, via computer 112, that a particular customer's service has been suspended, and that the driver of vehicle 110 should not service that particular customer on the route.

Payment-monitoring maybe be done based on the current status of customer accounts. Customer database 224 is queried for “Service Suspended” under “Collection Service Status” by billing software 220, in order to determine whether one or more customer accounts are delinquent. If a customer account is found to be delinquent, billing software 220 generates a first alert, for accounts that are one (I) month delinquent as recorded under “Months Delinquent”, which notifies relevant parties about a delinquent account. Notification can be provided, for example, by phone, email, and/or postal mail. Billing software 220 then monitors billing data to determine whether payment has been received. For example, if a credit card payment transaction has been performed online or via telephone, it is recorded under “Last Payment”. If payment has not been received, billing software 220 generates a second alert, for accounts that are two (2) months delinquent as recorded under “Months Delinquent”, which notifies relevant parties, for the second time, about a delinquent account. After a second alert, billing software 220 tags the customer account as delinquent in customer database 224 and service is suspended. Service can be reinstated when payment is received. The series of alerts described is not the only possible option, alerts may be sent more or less often and by different methods as necessary to receive payments.

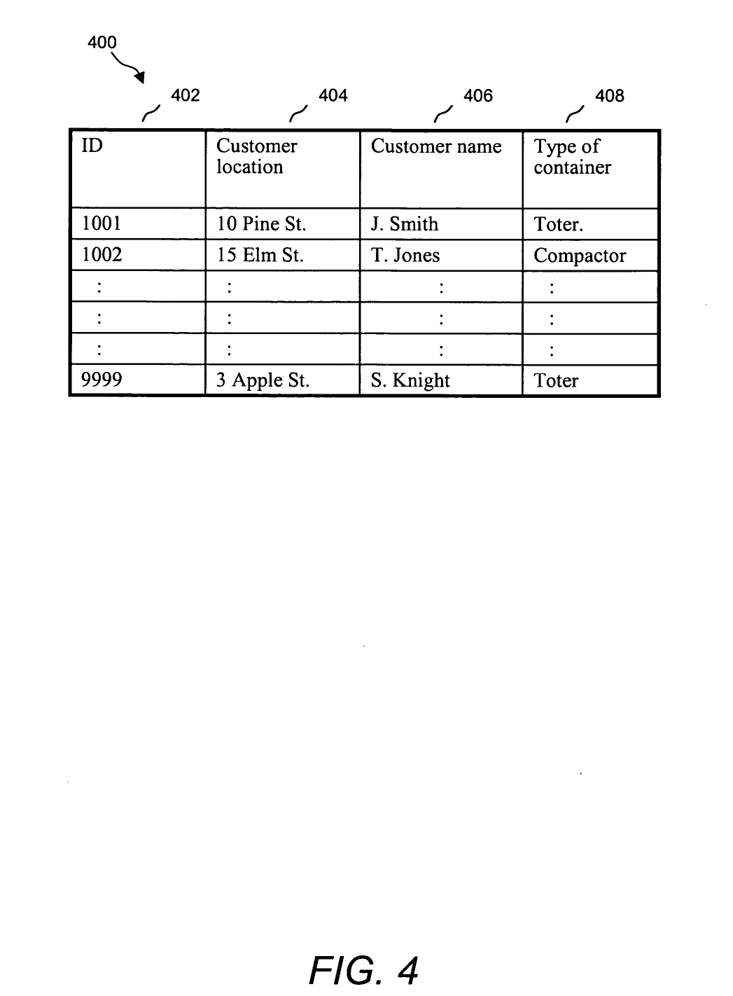

FIG. 4 is an exemplary data repository 400 of ID database 226 in accordance with an embodiment of the present invention. Repository 400 contains the identification code 402 of waste containers along with the customer 406 they are assigned to. Repository 400 also contains the location of the customer 404 the container 130 is assigned to, as well as the type 408 of container 130.

Repository 400 is used with identification reader 114 to determine the location of waste collection vehicle 110. Information scanned by identification reader from container ID mechanism 132 is compared to data contained within ID database 226 to determine if there is a match. The customer location from that match then corresponds to the location of waste collection vehicle 110 when the ID mechanism 132 was scanned. Columns 402, 404, 406, 408 are exemplary, and need not all be utilized in various embodiments. For example, instead of storing customer location 404 within ID database 226, only a customer name or ID number can be stored, and customer name or ID can be used to access the appropriate customer information in customer database 224.

Alternatively, container ID mechanism 132 can directly contain a customer code instead of an individual container ID. This customer code can be stored in customer database 224. The information scanned from container ID mechanism 132 can then be used to directly find the corresponding customer information and customer location in customer database 224 without having to use ID database 226, and/or without having to create multiple copies of customer information.

Other embodiments, extensions, and modifications of the ideas presented above are comprehended and within the reach of one skilled in the art upon reviewing the present disclosure. Accordingly, the scope of the present invention in its various aspects should not be limited by the examples and embodiments presented above. The individual aspects of the present invention, and the entirety of the invention should be regarded so as to allow for modifications and future developments within the scope of the present disclosure. The present invention is limited only by the claims that follow.

We claim:

1. A method of routing waste collection vehicles, comprising: determining a location of a waste collection vehicle on a route;
monitoring a data repository comprising a plurality of customer accounts, each customer account comprising a billing status and a customer location, for a change to the billing status of at least one customer account;
generating a route update based on detecting a change to the billing status of at least one customer account associated with the route and a location of the waste collection vehicle at the time of the detected change; and
transmitting the route update to the waste collection vehicle, thereby enabling the waste collection vehicle to provide service or not provide service at the customer location associated with the change to the billing status.

2. The method of claim 1, further comprising using a global positioning system to transmit position coordinates to the waste collection vehicle for use in determining the location of the waste collection vehicle.

3. The method of claim 1, further comprising:
reading at the customer location an identifier associated with a waste container;
transmitting wirelessly the read identifier to the data repository;
using the data repository to associate the read identifier with the customer location; and
using the customer location data to determine the location of the waste collection vehicle.

4. The method of claim 1, wherein a change to the billing status of a customer account occurs upon at least one of receiving a payment for the customer account and a passing of a predetermined time period after a payment due date for the customer account.

5. The method of claim 1, further comprising detecting a change to the billing status to reinstate service at the customer location.

6. The method of claim 5, wherein the detecting comprises:
comparing a payment credited to the customer account with an amount due;
calculating a difference between the payment credited and the amount due; and
reinstating a service associated with the customer account if the difference is less than or equal to a predetermined threshold.

7. The method of claim 1, further comprising detecting a change to the billing status to suspend service at the customer location.

8. The method of claim 7, wherein the detecting comprises:
comparing a payment due date associated with the customer account with a current date;
calculating a time difference between the payment due date and the current date; and
suspending a service associated with the customer account if the time difference is greater than or equal to a predetermined threshold.

9. The method of claim 1, further comprising notifying a customer when payment has not been received for a predetermined amount of time.

10. A system, comprising:
a data repository comprising data pertaining to a plurality of customer accounts, wherein each customer account comprises a billing status and a customer location; and
a computer, communicating with the data repository, that receives information pertaining to a location of a waste collection vehicle, and utilizes the waste collection vehicle location and a change to the billing status of a customer account to generate a route for the waste collection vehicle, based on the change to customer billing status and the location of the waste collection vehicle at the time of the change, indicating whether the waste collection should provide service or not provide service at the customer location associated with the change to the billing status.

11. The billing system according to claim 10, further comprising a transceiver that receives the route information from the computer and transmits the route information to the waste collection vehicle.

12. The system of claim 11, wherein a global positioning system transmits the waste collection vehicle location to the computer.

13. The system of claim 10, further comprising:
a waste container, at the customer location, having an identifier associated therewith;
a transmitter, associated with the waste collection vehicle, that wirelessly transmits data read from the identifier to the data repository, thereby enabling the data repository to be used to provide a present location of the waste collection vehicle.

14. The system of claim 10, wherein a change to the billing status to reinstate a customer comprises:
comparing a payment credited to the customer account with an amount due;
calculating a difference between the payment credited and the amount due; and
changing the billing status of the customer account to reinstate service if the difference is less than or equal to a predetermined threshold.

15. The system of claim 10 wherein a change to the billing status to suspend service associated with a customer account comprises:
comparing a payment deadline associated with the customer account with a current time;
calculating a time difference between the payment deadline and the current time; and
changing the billing status of the customer account to a suspended status if the time difference is greater than or equal to a predetermined threshold.

16. The system of claim 10, wherein a notification is sent to a customer based on the customer billing status.
